(19) United States
(12) Patent Application Publication
(10) Pub. No.: US 2016/0087550 A1
(43) Pub. Date: Mar. 24, 2016

(54) VIBRATOR, ELECTRONIC APPARATUS, AND MOVING OBJECT

(71) Applicant: Seiko Epson Corporation, Tokyo (JP)

(72) Inventors: Kazuyuki NAGATA, Minowa (JP); Ryuji KIHARA, Matsumoto (JP)

(21) Appl. No.: 14/856,898

(22) Filed: Sep. 17, 2015

(30) Foreign Application Priority Data
Sep. 22, 2014 (JP) 2014-192708

(51) Int. Cl. H02N 1/00

(52) U.S. Cl. CPC H02N 1/006

(57) ABSTRACT

To reduce concentration of stress near a connection of a connection portion between a support portion and a fixed base portion of a vibration section of a MEMS vibrator and to achieve a reduction in vibration leakage, a structure of the vibrator includes a portion which extends from a fixed base portion and supports a vibration section and of which a width decreases in a direction directed from the fixed base portion to the vibration section.

### BACKGROUND

1. Technical Field

The present invention relates to a vibrator, an electronic apparatus, and a moving object.

2. Related Art

Micro Electro Mechanical System (MEMS) structures manufactured using MEMS technologies are applied to various structures (for example, vibrators, filters, sensors, and motors) having movable units. MEMS vibrators have advantages that semiconductor circuits are easily incorporated and manufactured and are advantageous from the viewpoint of minuteness and high functioning, compared to resonators or vibrators using crystal or dielectric.

A MEMS resonator which is an example of the MEMS vibrators and is disclosed in JP-A-2012-178711 includes a substrate, an anchor portion fixed to a main surface of the substrate, and a floating structure connected to the anchor portion via a connection portion. In the MEMS resonator, the width of the anchor portion is gradually tapered toward the connection portion in order to reduce an anchor loss (vibration energy is lost via the anchor portion) and increase a Q value.

However, in the MEMS resonator disclosed in JP-A-2012-178711, there is a problem that the Q value is not sufficiently high.

Further, there is a possibility that the floating structure of the MEMS resonator disclosed in JP-A-2012-178711 vibrates in another mode (unnecessary vibration mode) as well as vibration (main vibration) when the MEMS resonator vibrates as a resonator at the time of operating.

When a vibration frequency of the unnecessary vibration mode described above is close to a frequency of the main vibration, there is a concern of vibration characteristics of the main vibration deteriorating due to combination of the main vibration and unnecessary vibration.

### SUMMARY

An advantage of some aspects of the invention is that it provides a vibrator having a high Q value and high vibration characteristics and an electronic apparatus and a moving object including the vibrator.

The invention can be implemented as the following forms or application examples.

### APPLICATION EXAMPLE 1

A vibrator according to this application example includes a substrate, a vibration section that is disposed on the substrate, a fixed base portion that is disposed on the substrate, and a support portion that extends from the fixed base portion to support the vibration section and has a portion of which a width decreases from the fixed base portion to the vibration section, in which in a connection portion between the fixed base portion and the support portion, a width of the support portion is less than a width of the fixed base portion.

Accordingly, it is possible to prevent stress from being concentrated near the connection portion between the support portion and the fixed base portion, and thus it is possible to design a reduction in vibration leakage. Further, it is possible to ensure a constant frequency difference between a resonant frequency of a main vibration mode and a resonant frequency of an unnecessary vibration mode. As a result, it is possible to prevent vibration characteristics from deteriorating while suppressing the decrease in a Q value by the vibration leakage. That is, it is possible to obtain the vibrator with the high Q value and the high vibration characteristics.

### APPLICATION EXAMPLE 2

In the vibrator according to the application example, it is preferable that the portion with the decreasing width in the support portion is connected to the fixed base portion in the connection portion.

With this configuration, it is possible to further reduce the vibration leakage.

### APPLICATION EXAMPLE 3

It is preferable that the vibrator according to the application example further includes a substrate-side electrode that is disposed on the substrate, and a movable electrode that faces the substrate-side electrode and at least partially overlaps the substrate-side electrode in a plan view when viewed in a thickness direction of the substrate, in which in the substrate-side electrode and the movable electrode are separated from each other.

With this configuration, it is possible to realize the vibrator of an electrostatic driving scheme.

### APPLICATION EXAMPLE 4

In the vibrator according to the application example, it is preferable that a plurality of movable electrodes are present.

With this configuration, it is possible to reduce the vibration leakage from the movable electrode to the outside. As a result, it is possible to improve the Q value of the vibrator.

### APPLICATION EXAMPLE 5

In the vibrator according to the application example, it is preferable that a part of the fixed base portion is fixed to the substrate.

With this configuration, it is possible to ensure a long distance between a concentration portion of stress occurring near the connection portion between the fixed base portion and the support portion with the vibration and the portion to which the fixed base portion is fixed, and thus it is possible to prevent the vibration characteristics of the vibrator from deteriorating.

### APPLICATION EXAMPLE 6

In the vibrator according to the application example, it is preferable that in the connection portion between the fixed base portion and the support portion, the width of the support portion is equal to or less than the width of the fixed base portion by 86%.

With this configuration, it is possible to suppress combination of the vibration of the main vibration mode and the vibration of the unnecessary vibration mode, and thus it is possible to prevent the vibration characteristics from deteriorating.

### APPLICATION EXAMPLE 7

In the vibrator according to the application example, it is preferable that in the connection portion between the fixed base portion and the support portion, the width of the support portion is equal to or greater than the width of the fixed base portion by 54%.

With this configuration, the function of the portion of which the width decreases from the fixed base portion to the vibration portion in the support portion is sufficiently exerted, and thus it is possible to reliably balance an improvement in the Q value and an improvement in the vibration characteristics.

### APPLICATION EXAMPLE 8

In the vibrator according to the application example, it is preferable that in a portion in which the width of the support portion is less than the width of the fixed base portion, an external shape of the portion in the plan view has a curved portion.

With this configuration, it is possible to realize the vibrator having the higher Q value and the excellent vibration characteristics.

### APPLICATION EXAMPLE 9

In the vibrator according to the application example, it is preferable that in a portion in which the width of the support portion is less than the width of the fixed base portion, an external shape of the portion in the plan view has a straight line portion.

With this configuration, the manufacturing is relatively easy, and thus it is possible to obtain the vibrator for which an individual difference in the shape is suppressed.

### APPLICATION EXAMPLE 10

In the vibrator according to the application example, it is preferable that a plurality of the fixed base portions and a plurality of the support portions are present.

With this configuration, it is possible to stably support the vibration section by the plurality of fixed base portions and the plurality of support portions. As a result, the vibration characteristics of the vibrator can be configured to be excellent.

### APPLICATION EXAMPLE 11

An electronic apparatus according to this application example includes the vibrator according to the application example.

With this configuration, it is possible to obtain the electronic apparatus with high reliability.

### APPLICATION EXAMPLE 12

A moving object according to this application example includes the vibrator according to the application example.

With this configuration, it is possible to obtain the moving object with high reliability.

### BRIEF DESCRIPTION OF THE DRAWINGS

The invention will be described with reference to the accompanying drawings, wherein like numbers reference like elements.

FIG. 1 is a sectional view illustrating a vibrator according to an embodiment of the present invention.

FIGS. 2A and 2B are a section view and a plan view illustrating a vibration element included in the vibrator illustrated in FIG. 1, respectively.

FIG. 3 is a partially expanded plan view illustrating a fixed base portion and a support portion of the vibration element illustrated in FIGS. 2A and 2B.

FIG. 4 is a perspective view for describing an operation of the vibration element included in the vibrator illustrated in FIG. 1.

FIGS. 5A to 5D are plan views illustrating modification examples of a vibration section included in the vibrator illustrated in FIG. 1.

FIG. 6A is a plan view illustrating the dimensions of the fixed base portion, a movable electrode (vibration section), and the support portion used when a Q value by vibration leakage and a resonant frequency in each vibration mode are analyzed according to a finite element method.

FIG. 6B is a side view illustrating each portion illustrated in FIG. 6A.

FIG. 7 is a partially expanded view illustrating a portion near a first beam portion illustrated in FIG. 6A.

FIGS. 8A to 8C are diagrams illustrating analysis results indicating a displacement state of the vibration section in vibration of each vibration mode, FIG. 8A is a diagram illustrating an analysis result indicating a displacement state of the vibration section in vibration of a main vibration mode, FIG. 8B is a diagram illustrating an analysis result indicating a displacement state of the vibration section in vibration of a first unnecessary vibration mode (unnecessary vibration mode 1), and FIG. 8C is a diagram illustrating an analysis result indicating a displacement state of the vibration section in vibration of a second unnecessary vibration mode (unnecessary vibration mode 2).

FIG. 9A is a diagram illustrating a relation between the length of the bottom side of a tapered portion and a Q value to which an anchor loss is reflected.

FIG. 9B is a diagram illustrating a relation between the length of the bottom side of the tapered portion and a resonant frequency of each vibration mode.

FIGS. 10A and 10B are diagrams illustrating another configuration example of the first beam portion illustrated in FIG. 7.

FIGS. 11A to 11E are diagrams illustrating processes of manufacturing the vibrator illustrated in FIG. 1.

FIGS. 12A to 12E are diagrams illustrating processes of manufacturing the vibrator illustrated in FIG. 1.

FIGS. 13A to 13C are diagrams illustrating processes of manufacturing the vibrator illustrated in FIG. 1.

FIG. 14 is a perspective view illustrating the configuration of a mobile (or notebook type) personal computer which is a first example of an electronic apparatus according to the invention.

FIG. 15 is a perspective view illustrating the configuration of a mobile phone (including a PHS) which is a second example of the electronic apparatus according to the invention.

FIG. 16 is a perspective view illustrating the configuration of a digital still camera which is a third example of the electronic apparatus according to the invention.

FIG. 17 is a perspective view illustrating the configuration of an automobile which is an example of a moving object according to the invention.

### DESCRIPTION OF EXEMPLARY EMBODIMENTS

Hereinafter, a vibrator, an electronic apparatus, and a moving object according to the invention will be described in detail with reference to the appended drawings according to embodiments.

### 1. Vibrator

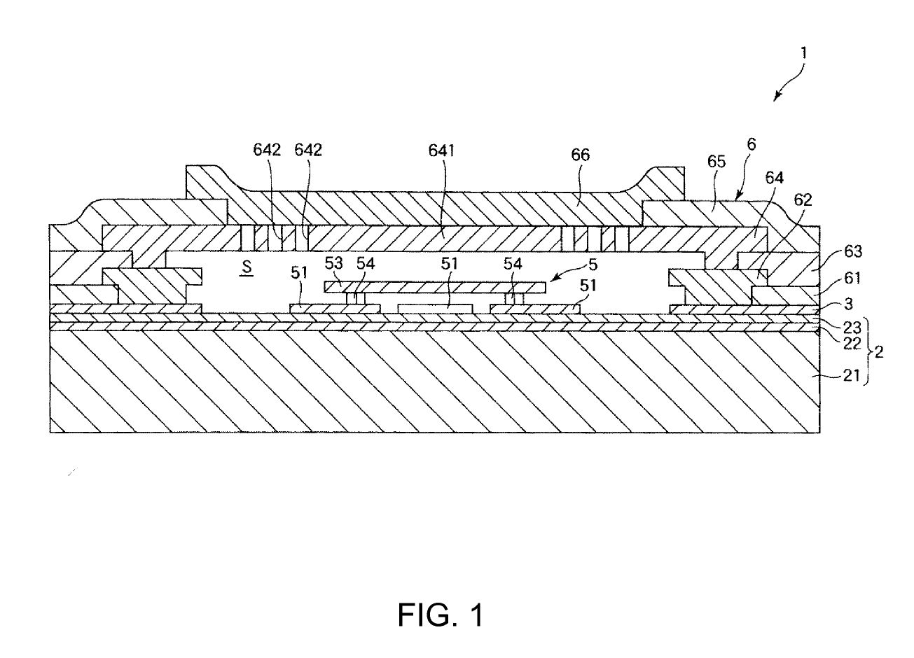

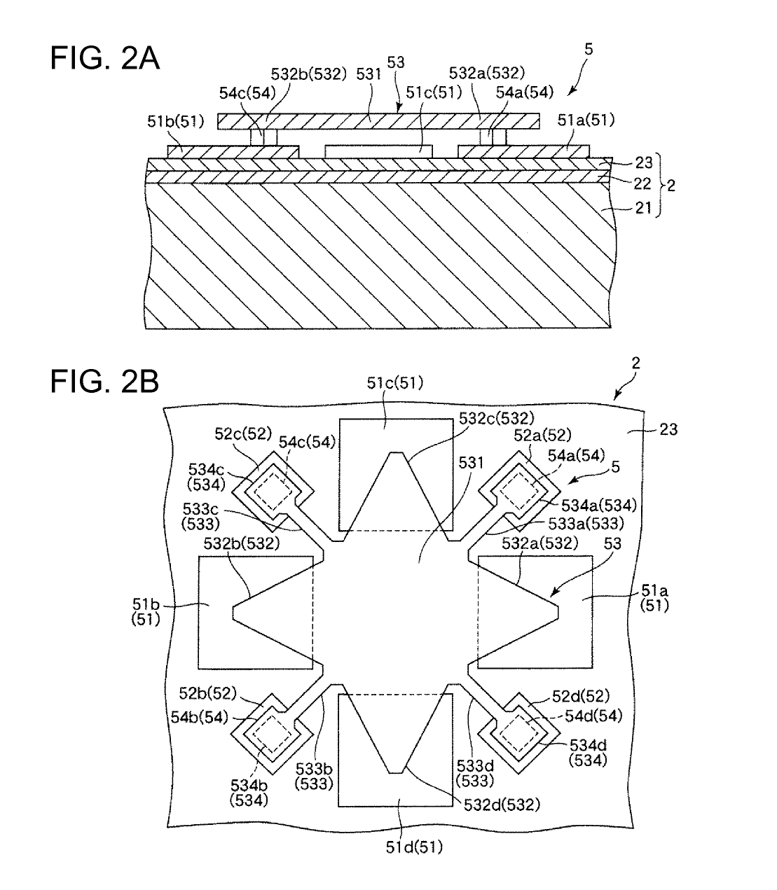

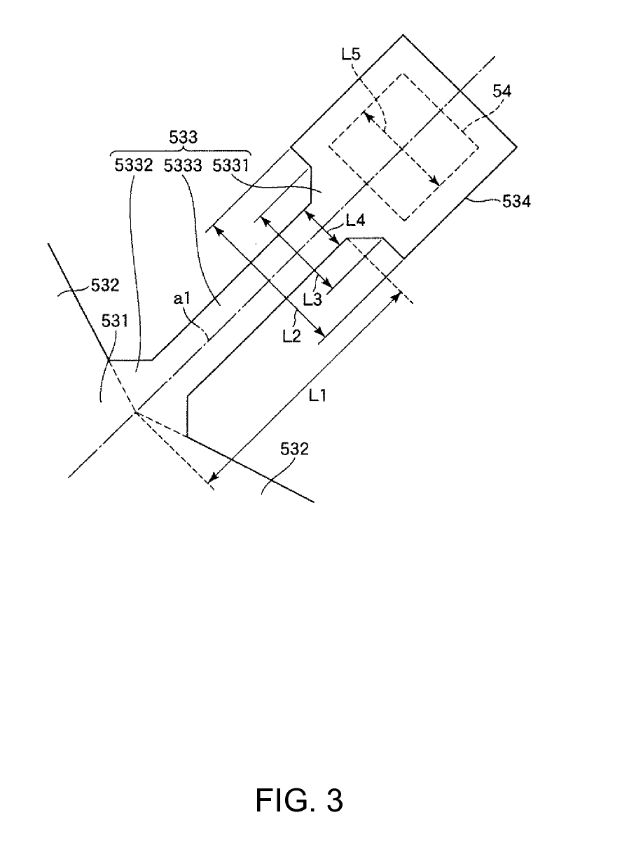

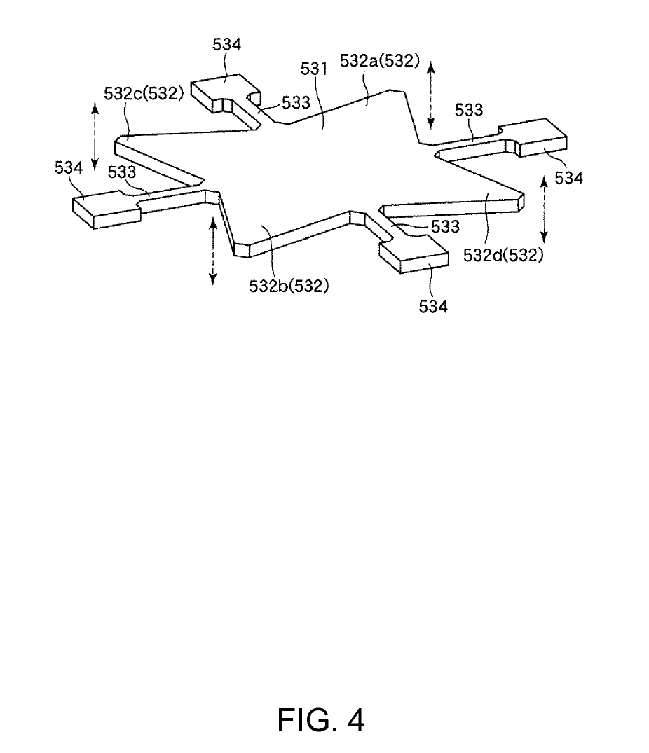

FIG. 1 is a sectional view illustrating a vibrator according to an embodiment of the invention. FIGS. 2A and 2B are a section view and a plan view illustrating a vibration element included in the vibrator illustrated in FIG. 1, respectively. FIG. 3 is a partially expanded plan view illustrating a fixed base portion and a support portion of the vibration element illustrated in FIGS. 2A and 2B. FIG. 4 is a perspective view for describing an operation of the vibration element included in the vibrator illustrated in FIG. 1.

A vibrator 1 illustrated in FIG. 1 includes a substrate 2 (base substrate), a vibration element 5 disposed above the substrate 2, and a laminated structure 6 in which a hollow portion S (cavity) accommodating the vibration element 5 is formed between the substrate 2 and the laminated structure 6. In the embodiment, a conductor layer 3 is disposed between the substrate 2 and the laminated structure 6. Hereinafter, such constituent elements will be described sequentially.

### Substrate 2

The substrate 2 includes a semiconductor substrate 21, an insulation film 22 that is provided on one surface of the semiconductor substrate 21, and an insulation film. 23 that is provided on the opposite surface of the insulation film 22 to the semiconductor substrate 21.

The semiconductor substrate 21 is formed of a semiconductor such as silicon. The semiconductor substrate 21 is not limited to a substrate formed of a single material such as a silicon substrate, but may be, for example, a substrate having a laminated structure such as an SOI substrate.

The insulation film 22 is, for example, a silicon oxide film and has an insulation property. The insulation film 23 is, for example, a silicon nitride film, has an insulation property, and resistance to an etchant including a hydrofluoric acid. Here, since the insulation film. 22 (silicon oxide film) is interposed between the semiconductor substrate 21 (silicon substrate) and the insulation film 23 (silicon nitride film), it is possible to alleviate transfer of stress occurring at the time of forming of the insulation film 23 to the semiconductor substrate 21 by the insulation film 22. The insulation film 22 can also be used as an inter-element separation film when the semiconductor substrate 21 and a semiconductor circuit above the semiconductor substrate 21 are formed. The insulation films 22 and 23 are not limited to the above-described constituent materials. One of the insulation films 22 and 23 may be omitted, as necessary.

The conductor layer 3 subjected to patterning is disposed on the insulation film 23 of the substrate 2. The conductor layer 3 is formed by doping (diffusing or injecting) impurities such as phosphorous or boron in monocrystalline silicon, polycrystalline silicon (polysilicon), or amorphous silicon, and thus has conductivity. Although not illustrated, the conductor layer 3 is subjected to patterning so that the conductor layer 3 includes a first portion forming wiring electrically connected to the vibration element 5 and a second portion separated and electrically insulated from the first portion.

### Vibration Element 5

As illustrated in FIGS. 2A and 2B, the vibration element 5 includes four lower electrodes 51 and four lower electrodes 52 disposed on the insulation film 23 of the substrate 2, an upper electrodes 53, and spacers 54 provided between each lower electrode 52 and the upper electrode 53.

The four lower electrodes 51 (fixed electrodes) are configured as two lower electrodes 51a and 51b arranged in the right and left directions of FIG. 2B in a plan view when viewed in the thickness direction of the substrate 2 (hereinafter simply referred to as a “plan view”) and two lower electrodes 51c and 51d arranged in the upper and lower directions of FIG. 2B over a region between the two lower electrodes 51a and 51b.

The four lower electrodes 52 are configured as a lower electrode 52a disposed to correspond between the lower electrodes 51a and 51c, a lower electrode 52b disposed to correspond between the lower electrodes 51b and 51d, a lower electrode 52c disposed to correspond between the lower electrodes 51b and 51c, and a lower electrode 52d disposed to correspond between the lower electrodes 51a and 51d in the plan view.

The lower electrodes 51 and 52 are disposed to be separated from each other in a plate shape or a sheet shape along the substrate 2. Although not illustrated, the four lower electrodes 51 are each electrically connected to wiring included in the conductor layer 3 described above. Similarly, at least two of the four lower electrodes 52 are electrically connected to the wiring included in the conductor layer 3 described above. Here, the lower electrodes 51 form “substrate-side electrodes” and the two lower electrodes 51a and 51b are electrically connected to each other via wiring (not illustrated) so that these lower electrodes have the same potential. Similarly, the two lower electrodes 51c and 51d are electrically connected to each other via wiring (not illustrated) so that these lower electrodes have the same potential. The shapes of the lower electrodes 51 and 52 in the plan view are not limited to the illustrated shapes. The lower electrodes 52 may be formed to be integrated with the lower electrodes 51 or may be omitted depending on the heights of the spacers 54.

The upper electrode 53 includes a vibration base portion 531, four movable portions 532 extending from the vibration base portion 531, four fixed base portions 534, and four support portions 533 (beam portions) connecting the vibration base portion 531 to the four fixed base portions 534. Here, a structure formed by the vibration base portion 531 and the four movable portions 532 is configured as a “vibration section” facing the substrate 2.

The four movable portions 532 extend from the vibration base portion 531 in different directions so that the structure (vibration section) formed by the vibration base portion 531 and the four movable portions 532 forms a substantially cross shape.

The four movable portions 532 are provided to correspond to the above-described four lower electrodes 51 and face (are separated from) the corresponding lower electrodes 51 at intervals. That is, the four movable portions 532 are configured as two movable portions 532a and 532b arranged in the right and left directions of FIG. 2B with the movable base portion 531 interposed therebetween in the plan view and two movable portions 532c and 532d arranged in the upper and lower directions of FIG. 2B with the movable base portion 531 interposed therebetween.

Thus, at least some of the movable portions 532 overlap the lower electrodes 51 disposed on the substrate 2 in the plan view, so that the vibrator 1 of an electrostatic driving scheme can be realized.

In the embodiment, each movable portion 532 has a shape in which a width decreases as it is separated from the vibration base portion 531 in the plan view. Thus, since stress occurring with vibration near a root of a side surface of the movable portion 532 (an end on the side of the vibration base portion 531) is easily concentrated, vibration leakage can be reduced.

The four fixed base portions 534 are each disposed on the substrate 2. Specifically, the four fixed base portions 534 are provided to correspond to the above-described four lower electrodes 52 and are each fixed to the corresponding lower electrodes 52 via the spacers 54. That is, the four fixed base portions 534 are configured as a fixed base portion 534a that is fixed to the lower electrode 52a via a spacer 54a, a fixed base portion 534b that is fixed to the lower electrode 52b via a spacer 54b, a fixed base portion 534c that is fixed to the lower electrode 52c via a spacer 54c, and a fixed base portion 534d that is fixed to the lower electrode 52d via a spacer 54d. Thus, the vibration section is fixed to the substrate 2 via the spacers 54, the fixed base portions 534, and the support portions 533.

Each fixed base portion 534 is rectangular in the plan view. Each spacer 54 is rectangular in the plan view, that is, each has the similar shape as the fixed base portion 534. In the embodiment, four sides of the shape (rectangle) of each fixed base portion 534 and each spacer 54 in the plan view are configured as a pair of sides parallel to a central line of the corresponding support portion 533 and a pair of sides perpendicular to the center line.

The four support portions 533 are provided to correspond to the four fixed base portions 534 and each connect the corresponding fixed base portions 534 to the vibration base portion 531. That is, the four support portions 533 are configured as a support portion 533a connecting the fixed base portion 534a to the vibration base portion 531, a support portion 533b connecting the fixed base portion 534b to the vibration base portion 531, a support portion 533c connecting the fixed base portion 534c to the vibration base portion 531, and a support portion 533d connecting the fixed base portion 534d to the vibration base portion 531.

Thus, since the plurality of fixed base portions 534 and the plurality of support portions 533 are present, the structure (vibration section) formed by the vibration base portion 531 and the movable portions 532 can be stably supported. As a result, the vibrator 1 can have excellent vibration characteristics.

Here, as illustrated in FIG. 3, each support portion 533 includes a first beam portion 5331 located in a connection portion with the fixed base portion 534, a second beam portion 5332 located in a connection portion with the vibration base portion 531, and a third beam portion 5333 located between the first beam portion 5331 and the second beam portion 5332. The first beam portion 5331, the second beam portion 5332, and the third beam portion 5333 are arranged along a central line al linking the vibration base portion 531 to the fixed base portion 534, as illustrated in FIG. 3.

The first beam portion 5331 extends along the central line al in the plan view. The width of the first beam portion 5331, that is, the length of the first beam portion 5331 in a direction perpendicular to the central line al, continuously decreases from the fixed base portion 534 to the vibration base portion 531 (from the fixed base portion to the vibration section).

The width of the first beam portion 5331 is less than the width of the fixed base portion 534, that is, the length of the fixed base portion 534 in the direction perpendicular to the central line al. In other words, the maximum width of the first beam portion 5331 (the width of a portion of the first beam portion 5331 closest to the side of the fixed base portion 534) is less than the width of the fixed base portion 534.

By configuring the first beam portion 5331 described above, the vibration leakage in the connection portion between the fixed base portion 534 and the support portion 533 is designed to be reduced. Thus, it is possible to improve the Q value of the vibrator 1, and it is possible to suppress deterioration in the vibration characteristics in combination with vibration of a mode (main vibration mode) and a different mode (unnecessary vibration mode) from this mode when the vibrator 1 operates a resonator. Concentration of stress on the connection portion between the fixed base portion 534 and the support portion 533 is reduced, and thus it is possible to improve an impact-resistant property of the vibrator 1. These points will be described in detail below.

The second beam portion 5332 also extends along the central line al in the plan view. The width of the second beam portion 5332, that is, the length of the second beam portion 5332 in the direction perpendicular to the central line al, continuously decreases from the fixed base portion 534 to the vibration base portion 531 (from the fixed base portion to the vibration section). Thus, reduction in vibration leakage is achieved in a connection portion between the vibration base portion 531 and the support portion 533. As a result, it is possible to suppress a decrease in the Q value. In addition to this, by providing the second beam portion 5332, concentration of stress on the connection portion between the vibration base portion 531 and the support portion 533 is reduced, and thus it is possible to improve an impact-resistant property of the vibrator 1.

The second beam portion 5332 may be provided, as necessary, and may be omitted.

The third beam portion 5333 also extends along the central line al in the plan view. The width of the third beam portion 5333, that is, the length of the third beam portion 5333 in the direction perpendicular to the central line al, is substantially constant.

The third beam portion 5333 according to the embodiment extends in a straight line shape along the central line al, as illustrated in FIG. 3, but may be bent or crooked halfway.

The fixed base portion 534 and the spacer 54 are rectangular in the plan view, as described above, and the centers of the rectangles are configured to overlap the central line al.

The centers of the fixed base portion 534 and the spacer 54 may be deviated from the central line al. The above-described four sides of the shapes of the fixed base portion 534 and the spacer 54 in the plan view may not be parallel or perpendicular to the central line al or may be inclined.

The above-described lower electrodes 51 and 52, upper electrodes 53, and spacer 54 are formed by doping (diffusing or injecting) impurities such as phosphorous or boron in monocrystalline silicon, polycrystalline silicon (polysilicon), or amorphous silicon, and thus has conductivity. The spacer 54 may be formed to be integrated with the lower electrode 52 or the upper electrode 53.

The film thicknesses of the lower electrodes 51 and 52 are not particularly limited, but are preferably equal to or greater than 0.1 μm and equal to or less than 1.0 μm, for example. The film thickness of the upper electrode 53 is not particularly limited, but is preferably equal to or greater than 0.1 μm and equal to or less than 10.0 The thickness of the spacer 54 is not particularly limited as long as vibration of the movable portion 532 is allowable, but is preferably equal to or greater than 0.03 μm and equal to or less than 2.0 μm.

### Laminated Structure 6

The laminated structure 6 is formed so that the hollow portion S accommodating the vibration element 5 is partitioned. The laminated structure 6 includes an inter-layer insulation film. 61 that is formed on the substrate 2 to surround the vibration element 5 in the plan view, a wiring layer 62 that is formed on the inter-layer insulation film 61, an inter-layer insulation film 63 that is formed on the wiring layer 62 and the inter-layer insulation film 61, a wiring layer 64 that is formed on the inter-layer insulation film 63 and includes a covering layer 641 in which a plurality of pores 642 (openings) are formed, a surface protection film 65 that is formed between the wiring layer 64 and the inter-layer insulation film 63, and a sealing layer 66 that is provided on the covering layer 641.

The inter-layer insulation films 61 and 63 are, for example, silicon oxide films. The wiring layers 62 and 64 and the sealing layer 66 are formed of a metal such as aluminum. The surface protraction film 65 is, for example, a silicon nitride film.

Semiconductor circuits may be formed on or above the semiconductor 21 as well as the above-described configuration. The semiconductor circuit includes circuit elements such as an active element such as a MOS transistor and a capacitor, an inductor, a resistor, a diode, wiring (including wiring connected to the lower electrode 51, wiring connected to the upper electrode 53, and the wiring layers 62 and 64) formed as necessary. Although not illustrated, between the wiring layer 62 and the insulation film 23, wiring electrically connected to the above-described vibration element 5 is disposed outside and inside the hollow portion S and the wiring layer 62 is formed to be separated from this wiring.

The hollow portion S partitioned by the substrate 2 and the laminated structure 6 functions as a reception portion that accommodates the vibration element 5. The hollow portion S is a sealed space. In the embodiment, the hollow portion S is in a vacuum state (equal to or less than 300 Pa). Thus, the vibration element 5 can have excellent vibration characteristics. However, the hollow portion S may not be in a vacuum state, may be under atmospheric pressure, may be in a depressurized state of which a pressure is less than atmospheric pressure, or may be in a pressurized state of which a pressure is higher than atmospheric pressure. An inert gas such as a nitrogen gas or a rare gas may be sealed in the hollow portion S.

The configuration of the vibrator 1 has been described above in brief.

In the vibrator 1 having such a configuration, a periodically varying first voltage (alternating voltage) is applied between the lower electrodes 51a and 51b and the upper electrode 53 and a second voltage which is the same as the first voltage is applied between the lower electrodes 51c and 51d and the upper electrode 53 except that the phase is shifted by 180°.

Then, the movable portions 532a and 532b are displaced to bend and vibrate alternately in an approach direction and a recession direction to and from the lower electrodes 51a and 51b, and the movable portions 532c and 532d are displaced to bend and vibrate alternately in an approach direction and a recession direction to and from the lower electrodes 51c and 51d at a reverse phase to the movable portions 532a and 532b. That is, as illustrated in FIG. 4, a displacement state of the movable portions 532a, 532b, 532c, and 532d in directions indicated by solid arrows in FIG. 4 and a displacement state of the movable portions 532a, 532b, 532c, and 532d in directions indicated by dotted arrows in FIG. 4 are alternately repeated.

By vibrating the plurality of movable portions at the reverse phase in this way, specifically, the movable portions 532a and 532b and the movable portions 532c and 532d at the reverse phase, it is possible to mutually cancel the vibration transferred from the movable portions 532a and 532b to the vibration base portion 531 and the vibration transferred from the movable portion 532c and 532d to the vibration base portion 531. As a result, it is possible to reduce leakage of such vibration to the outside (the substrate 2) via the vibration base portion 531, the support portions 533, and the fixed base portions 534, that is, so-called vibration leakage, and thus it is possible to improve the vibration efficiency of the vibrator 1. Thus, in the vibrator 1, the number of movable portions 532 is plural. Therefore, it is possible to reduce the vibration leakage from the movable portions 532 to the outside. As a result, it is possible to improve the Q value.

The vibrator 1 can be combined with, for example, an oscillation circuit (driving circuit) to be used as an oscillator extracting a signal with a predetermined frequency. The oscillator circuit can be provided as a semiconductor circuit on the substrate 2. The vibrator 1 can also be applied to various sensors such as a gyro sensor, a pressure sensor, an acceleration sensor, and an inclination sensor.

The number of movable portions is not limited to four, as illustrated in FIGS. 2A and 2B, but two or three movable portions may be used or five or more movable portions may be used. The shapes of the movable portions are not limited to the shapes illustrated in FIGS. 2A and 2B.

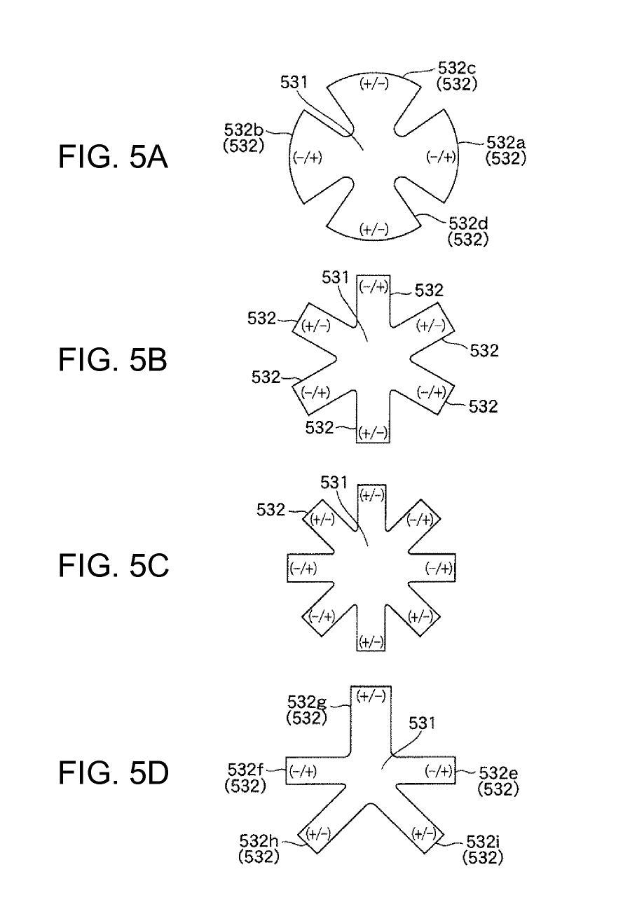

FIGS. 5A to 5D are plan views illustrating modification examples of the vibration section included in the vibrator illustrated in FIG. 1. In FIGS. 5A to 5D, the fixed base portions and the support portions are not illustrated. A sign such as (+/−) illustrated in FIGS. 5A to 5D indicates a displacement direction in the antinode of vibration, and + and − indicate that the displacement directions are mutually opposite. For example, a sign (−/+) is affixed to the movable portion 532a in FIG. 5A and the sign (+/−) is affixed to the movable portion 532c. Therefore, in this case, these signs indicate that the movable portion 532c is displaced in a rearward direction of the sheet at a timing at which the movable portion 532a is displaced in a frontward direction of the sheet and, in contrast, the movable portion 532c is displayed in the frontward direction of the sheet at a timing at which the movable portion 532a is displaced in the rearward direction of the sheet.

The vibration section illustrated in FIG. 5A is a structure that includes the vibration base portion 531 and four movable portions 532a, 532b, 532c, and 532d extending from the vibration base portion 531. The four movable portions 532 have a shape of which a width increases as separated from the vibration base portion 531 in the plan view. A part of the external shape of each movable portion 532 is bent so that an arc is drawn.

When the vibration section vibrates so that the phases of vibration of the mutually adjacent movable portions 532 are mutually reversed, a high Q value is indicated.

The vibration section illustrated in FIG. 5B is a structure that includes the vibration base portion 531 and six movable portions 532 extending from the vibration base portion 531. Each of the six movable portions 532 has a shape of which a width is rarely changed (substantially constant) as they are separated from the vibration base portion 531 in the plan view.

When the vibration section vibrates so that the phases of the vibration of the mutually adjacent movable portions 532 are mutually reversed, a high Q value is indicated.

The vibration section illustrated in FIG. 5C is a structure that includes the vibration base portion 531 and eight movable portions 532 extending from the vibration base portion 531. Each of the eight movable portions 532 has a shape of which a width is rarely changed (substantially constant) as separated from the vibration base portion 531 in the plan view.

When the vibration section vibrates so that the phases of the vibration of the mutually adjacent movable portions 532 are mutually reversed or the vibration section vibrates so that the phases of the vibration of the two mutually adjacent movable portion 532, as described in FIG. 5C, are the same as one pair and the phases of the vibration of the mutually adjacent pairs of movable portions 532 are mutually reversed, a high Q value is indicated.

The vibration section illustrated in FIG. 5D is a structure that includes the vibration base portion 531 and five movable portions 532e, 532f, 532g, 532h, and 532i extending from the vibration base portion 531. Each of the five movable portions 532 has a shape of which a width is rarely changed (substantially constant) as separated from the vibration base portion 531 in the plan view.

In the vibration section, the width of the movable portion 532g (the length of the movable portion 532g in a direction perpendicular to the extension direction of the movable portion 532g) is greater than the width of the movable portion 532h and the width of the movable portion 532i. This is because the vibration of the entire vibration section is in balance in nodes of the vibration. When the vibration section has such a configuration, the vibration section having a high Q value can be obtained.

### Support Portion

Hereinafter, the support portion 533 will be described in detail.

In the support portions 533, as described above, the first beam portion 5331, the third beam portion 5333, and the second beam portion 5332 are arranged in this order along the central line al illustrated in FIG. 3 from the fixed base portion 534 to the vibration base portion 531.

As described above, the width of the first beam portion 5331 continuously decreases from the fixed base portion 534 to the vibration base portion 531.

As results of thorough examination under such assumption, the inventors have found that by causing the width of the first beam portion 5331 smaller than the width of the fixed base portion 534, that is, by causing the largest width of the portion in the first beam portion 5331 to be narrower than the width of the fixed base portion 534, it is possible to improve the Q value of the vibrator 1 by reducing the vibration leakage, and it is possible to suppress deterioration in the vibration characteristics in combination with vibration of a mode (main vibration mode) when the vibrator 1 operates as a resonator and vibration of a different mode (unnecessary vibration mode) from the main vibration mode. Hereinafter, this point will be described in detail.

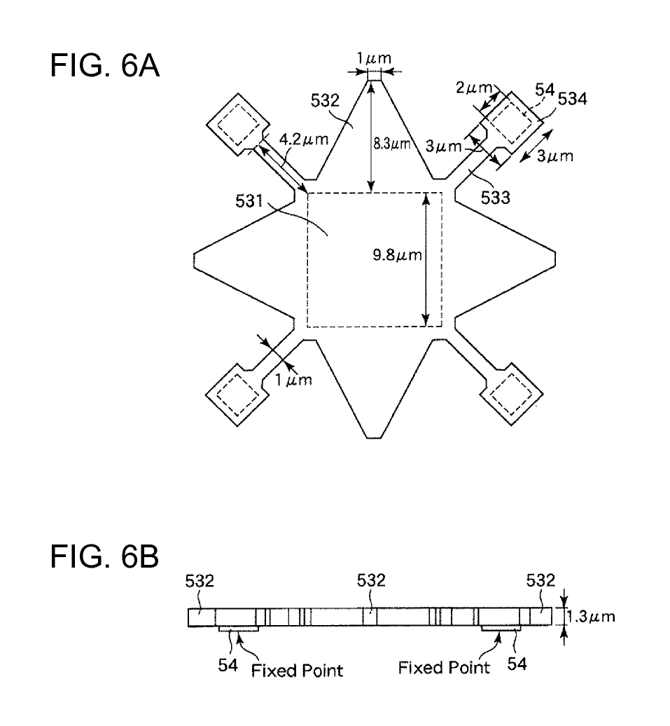

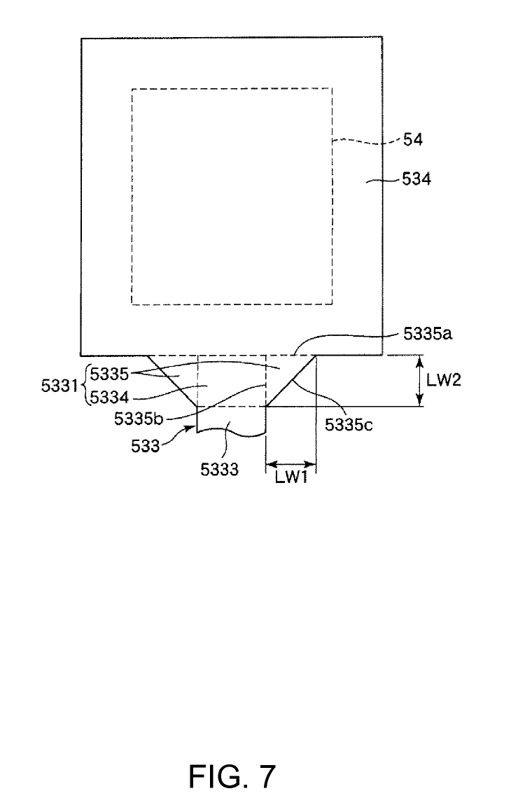

FIG. 6A is a plan view illustrating the dimensions of the fixed base portion, a movable electrode (vibration section), and the support portion used when the Q value by vibration leakage and a resonant frequency in each vibration mode are analyzed according to a finite element method. FIG. 6B is a side view illustrating each portion illustrated in FIG. 6A. FIG. 7 is a partially expanded view illustrating a portion near the first beam portion illustrated in FIG. 6A.

In a vibration element with dimensions illustrated in FIG. 6A, positions at which the spaces 54 are provided are set to fixed points and each shape of the first beam portion 5331 is analyzed according to the finite element method.

For the dimensions illustrated in FIG. 6A in the vibrator 1 illustrated in FIGS. 2A and 2B, in the plan view, the width of an end of each movable portion 532 on the side of the vibration base portion 531 is 9.8 μm, the width of a tip end of each movable portion 532 is 1 μm, the width of the support portion 533 is 1 μm, the length of each side of each fixed base portion 534 is 3 μm, and the length of each side of each spacer 54 is 2 μm. A length L1 (see FIG. 3) of each support portion 533 is 4.2 μm and the thickness of each portion is 1.3 μm.

On the other hand, a portion which has the same width as the third beam portion 5333 and is located on an extension of the third beam portion 5333 in the above-described first beam portion 5331 is particularly referred to as an “equi-width portion 5334.” The equi-width portion 5334 is rectangular in the plan view, as illustrated in FIG. 7.

In the first beam portion 5331, two portions located on both sides with the equi-width portion 5334 interposed therebetween are particularly “tapered portions 5335.” Each tapered portion 5335 has a right-angled triangle in the plan view, as illustrated in FIG. 7. Further, two sides forming the right angle of the right-angled triangle are referred to as “bottom sides 5335a and 5335b” of each tapered portion 5335, respectively. This analysis is performed assuming that the two bottom sides 5335a and 5335b of each tapered portion 5335 are the same between the tapered portions 5335. That is, in this analysis, the shape of the tapered portion 5335 is assumed to have an isosceles right triangle in the plan view. Of the two bottom sides 5335a and 5335b of the tapered portion 5335 in FIG. 7, the length of the bottom side 5335a extending in the right and left directions of FIG. 7 is assumed to be LW1 and the length of the bottom side 5335b extending in the upper and lower directions of FIG. 7 is assumed to be LW2.

In this analysis, shapes obtained by gradually changing the lengths LW1 and LW2 of the two bottom sides 5335a and 5335b of the tapered portion 5335 from 0 μm to 1 μm are created, and the Q value and a resonant frequency in vibration of each vibration mode (a main vibration mode and unnecessary vibration modes) by the vibration leakage are calculated for each shape.

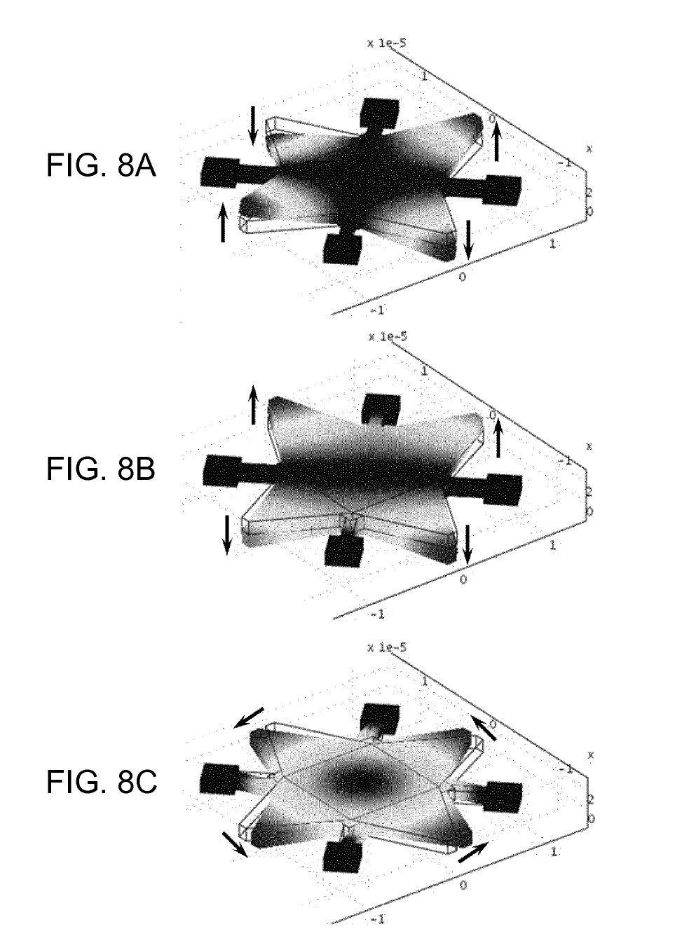

FIGS. 8A to 8C are diagrams illustrating analysis results indicating a displacement state of the vibration section in the vibration of each vibration mode. FIG. 8A is a diagram illustrating an analysis result indicating a displacement state of the vibration section in the vibration of the main vibration mode, FIG. 8B is a diagram illustrating an analysis result indicating a displacement state of the vibration section in the vibration of a first unnecessary vibration mode (unnecessary vibration mode 1), and FIG. 8C is a diagram illustrating an analysis result indicating a displacement state of the vibration section in the vibration of a second unnecessary vibration mode (unnecessary vibration mode 2). In each of FIGS. 8A to 8C, the shape of the vibration section before the displacement is indicated by solid lines drawn along the contour of the vibration section, and the shape of the vibration section after the vibration at a certain time is shown by a portion indicated by the shading.

In the main vibration mode illustrated in FIG. 8A, of the four movable portions 532, the two movable portions 532a and 532b located with the vibration base portion 531 interposed therebetween are displaced to bend and vibrate in the upper and lower directions of FIGS. 8A to 8C, and the movable portions 532c and 532d located with the vibration base portion 531 interposed therebetween are displaced to bend and vibrate in the upper and lower directions of FIGS. 8A to 8C at the reverse phase to the movable portions 532a and 532b.

In unnecessary vibration mode 1 illustrated in FIG. 8B, of the four movable portions 532, the two mutually adjacent movable portions 532a and 532c are displaced to bend and vibrate in the upper and lower directions of FIGS. 8A to 8C, and the two mutually adjacent movable portions 532b and 532d are displaced to bend and vibrate in the upper and lower directions of FIGS. 8A to 8C at the reverse phase to the movable portions 532a and 532c.

In unnecessary vibration mode 2 illustrated in FIG. 8C, the vibration section rotates and shakes (reciprocally rotates) while changing the rotation direction sequentially in a plane in which the vibration section spread.

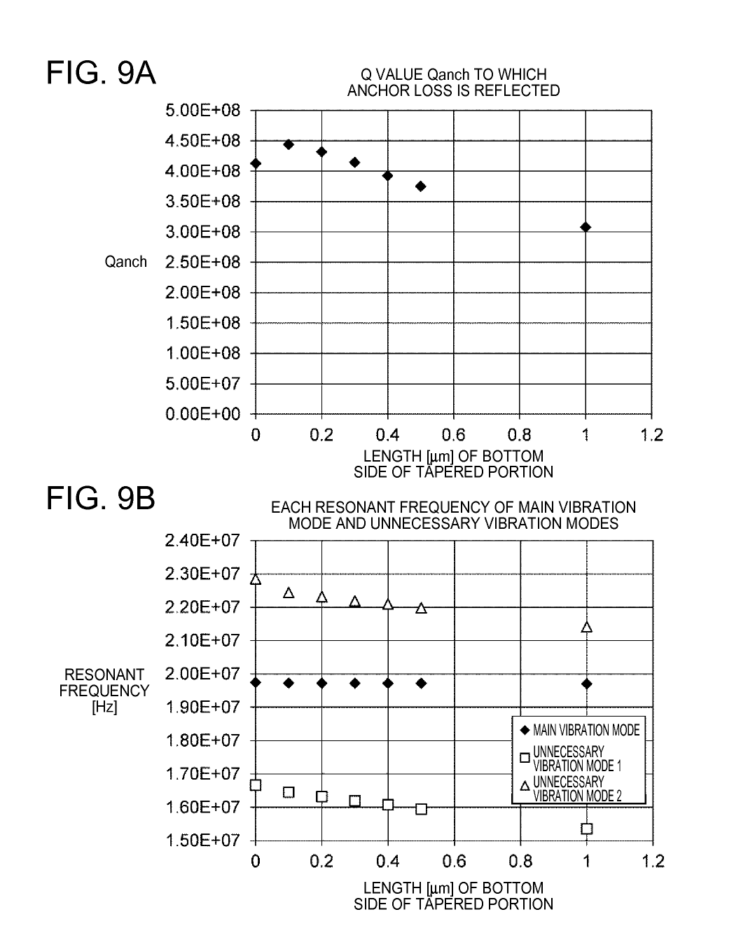

FIG. 9A is a diagram illustrating a relation between the length of the bottom side of the tapered portion 5335 and the Q value to which an anchor loss is reflected. FIG. 9B is a diagram illustrating a relation between the length of the bottom side of the tapered portion 5335 and a resonant frequency of each vibration mode.

Of the drawings, FIG. 9A is a diagram illustrating a relation between the length [μm] of the bottom side of the tapered portion 5335 and the Q value (Qanch) to which an anchor loss is reflected. The anchor loss refers to a loss of vibration energy in the connection portion between the support portion 533 and the fixed base portion 534. That is, when the vibration section vibrates in the main vibration mode, the fixed base portion 534 rarely vibrates. However, since torsional vibration occurs in the support portion 533, a loss of the vibration energy occurs in the connection portion between the support portion 533 and the fixed base portion 534. The loss of the vibration energy results in a reduction of the Q value of resonance.

For example, according to the analysis result illustrated in FIG. 9A, when the lengths LW1 and LW2 of the bottom sides 5335a and 5335b of the tapered portion 5335 are greater than 0 μm and equal to or less than 0.3 μm, an improvement in the Q value is designed more than when the lengths LW1 and LW2 of the bottom sides 5335a and 5335b of the tapered portion 5335 are 0 μm. In the analysis result illustrated in FIG. 9A, the lengths LW1 and LW2 of the bottom sides 5335a and 5335b of the tapered portion 5335 are preferably considered to be equal to or greater than 0.05 μm and equal to or less than 0.25 μm, and are more preferably considered to be equal to or greater than 0.05 μm and equal to or less than 0.20 μm.

The lengths LW1 and LW2 of the bottom sides 5335a and 5335b of the tapered portion 5335 are not limited to the case in which these lengths are the same, but may be different from each other. That is, the shape of the tapered portion 5335 in the plan view is not limited to the isosceles right triangle, but may be a right triangle in which the lengths of the two bottom sides are different from each other. In this case, from the viewpoint of suppressing the reduction in the Q value, LW1/LW2 is preferably equal to or greater than about 0.5 and equal to or less than about 2 and is more preferably equal to or greater than about 0.8 and equal to or less than about 1.2.

On the other hand, FIG. 9B is a diagram illustrating the relation between the lengths of the bottom sides 5335a and 5335b of the tapered portion 5335 and the resonant frequency of each of the main vibration mode, unnecessary vibration mode 1, and unnecessary vibration mode 2. As illustrated in FIG. 9B, as the lengths of the bottom surfaces 5335a and 5335b of the tapered portion 5335 are longer, a resonant frequency difference (hereinafter simply referred to as a “frequency difference”) between the main vibration mode and unnecessary vibration mode 1 or unnecessary vibration mode 2 tends to decrease. However, when the lengths of the bottom sides 5335a and 5335b of the tapered portion 5335 are equal to or less than 0.5 μm, the frequency difference is ensured with a width of 2×10⁶ Hz or more. In other words, it is possible to achieve the improvement in the Q value described above while suppressing the decrease in the frequency difference to the minimum by providing the tapered portion 5335. As a result, a probability of combination of the vibration of the main vibration mode and the vibration of the unnecessary vibration mode decreases, and thus the vibration of the main vibration mode can be designed to be stabilized. Thus, it is possible to improve the vibration characteristics of the vibrator 1. The above-described frequency difference refers to a smaller difference between a difference between the resonant frequency of the main vibration mode and the resonant frequency of unnecessary vibration mode 1 and a difference between the resonant frequency of the main vibration mode and the resonant frequency of unnecessary vibration mode 2.

The analysis results illustrated in FIGS. 9A and 9B are merely examples of the form illustrated in FIGS. 6A and 6B. It is estimated from the analysis results of a plurality of patterns that, as described above, the advantages of designing the improvement in the Q value and improving the resonant characteristics can be obtained from the configuration in which the width of the first beam portion 5331 decreases from the vibration base portion 531 to the fixed base portion 534 and the configuration in which the width of the first beam portion 5331 is less than the width of the fixed base portion 534.

As illustrated in FIG. 3, when the width of the fixed base portion 534 is assumed to be L2 and the width of the support portion 533, that is, the width of the first beam portion 5331, is assumed to be L3 in the plan view of the connection portion between the fixed base portion 534 and the support portion 533, “L2>L3” may be satisfied, as described above. L3/L2 is preferably considered to be equal to or less than 86%, is more preferably considered to be equal to or less than 80%, and is further more preferably considered to be equal to or less than 75%. Thus, it is possible to reliably balance the improvement in the Q value and the improvement in the vibration characteristics.

When L3/L2 is greater than an upper limit, the width of the support portion 533 (the first beam portion 5331) is too large and the rigidity of the support portion 533 easily increases. Therefore, there is a concern of the resonant frequency of unnecessary vibration mode 2 being increasing. As a result, the resonant frequency of the main vibration mode and the resonant frequency of unnecessary vibration mode 2 approach depending on the width of the support portion 533, and thus the vibration of the main vibration mode and the vibration of unnecessary vibration mode 2 are easily combined. Therefore, there is a concern of the vibration characteristics being deteriorating.

As illustrated in FIG. 3, in the plan view of the connection portion between the fixed base portion 534 and the support portion 533, L3/L2 is preferably considered to be equal to or greater than 54%, is more preferably considered to be equal to or greater than 60%, and is further more preferably considered to be equal to or greater than 65%. Thus, the function of the tapered portion 5335 is sufficiently exerted, and thus it is possible to reliably balance the improvement in the Q value and the improvement in the vibration characteristics.

When L3/L2 is less than a lower limit, the lengths of the bottom sides 5335a and 5335b of the tapered portion 5335 are shortened depending on the width of the equi-width portion 5334. Thus, there is a concern of the above-described advantages obtained from the tapered portion 5335 being decreasing.

As illustrated in FIG. 3, when the width of the third beam portion 5333 is assumed to be L4, “L3>L4” may be satisfied, as described above. L4/L3 is preferably considered to be equal to or greater than 30% and equal to or less than 95%, is more preferably considered to be equal to or greater than 40% and equal to or less than 85%, and is further more preferably considered to be equal to or greater than 50% and equal to or less than 80%. Thus, it is possible to reliably balance the improvement in the Q value and the improvement in the vibration characteristics.

When L4/L3 is less than a lower limit, the width of the third beam portion 5333 decreases depending on the width L3 of the first beam portion 5331. Thus, there is a concern of an impact-resistant property of the support portion 533 being deteriorating. Conversely, when L4/L3 is greater than an upper limit, the width L4 of the third beam portion 5333 considerably increases depending on the width L3 of the first beam portion 5331. Therefore, the rigidity of the support portion 533 increases, and thus, there is a concern of the resonant frequency of unnecessary vibration mode 2 being increasing. As a result, there is a concern of the vibration characteristics of the vibrator 1 being deteriorating.

In such a configuration, by providing the tapered portion 5335, a rigidity difference near the connection portion between the fixed base portion 534 and the support portion 533 is reduced. Therefore, even when an impact is applied to the vibrator 1, it is possible to prevent the connection portion from being damaged based on the rigidity difference. Thus, it is possible to improve the impact-resistant property of the vibrator 1.

The length L1 of each support portion 533 is appropriately set according to the size of the vibrator 1. For example, the length L1 is preferably set to be equal to or greater than about 1 μm and equal to or less than about 50 μm, and more preferably set to be equal to or greater than about 2 μm and equal to or less than about 20 μm.

The length L2 of the fixed base portion 534 is appropriately set according to the size of the vibrator 1. For example, the length L2 is preferably considered to be equal to or greater than about 1.5 μm and equal to or less than about 30 μm, and more preferably considered to be equal to or greater than about 2 μm and equal to or less than about 20 μm.

The width L5 of the spacer 54 (the length in a direction perpendicular to the central line al in the plan view and see FIG. 3) is less than the width L2 of the fixed base portion 534. Thus, it is possible to increase a distance between a portion in which a temperature increases due to heat generated near the connection portion between the fixed base portion 534 and the support portion 533 with the vibration and a portion (a portion in which the spacer 54 is provided) to which the fixed base portion 534 is fixed, and thus it is possible to prevent the vibration characteristics of the vibrator 1 from deteriorating.

From such a viewpoint, the width L5 of the spacer 54 is equal to or greater than the width L2 of the fixed base portion 534 preferably by 0.3 times or more and 0.9 times or less, and more preferably by 0.5 times or more and 0.8 times or less. However, when the width L5 of the spacer 54 is too large, there is a concern of the advantage of reducing the vibration leakage being reduced, as described above. Conversely, when the width of the spacer 54 is too small, the fixing of the fixed base portion 534 by the spacer 54 may be unstable or a portion protruding from the spacer 54 may easily vibrate depending on the height or the like of the spacer 54 of the fixed base portion 534. Thus, there is a concern of the vibration characteristics of the vibrator 1 being adversely affected.

When reference numeral 5335c denotes an oblique side of the tapered portion 5335 with the shape of the isosceles right triangle in the plan view, the shape of the oblique side 5335c in the plan view may be a straight line, as illustrated in FIG. 7, or may be a shape other than the straight line.

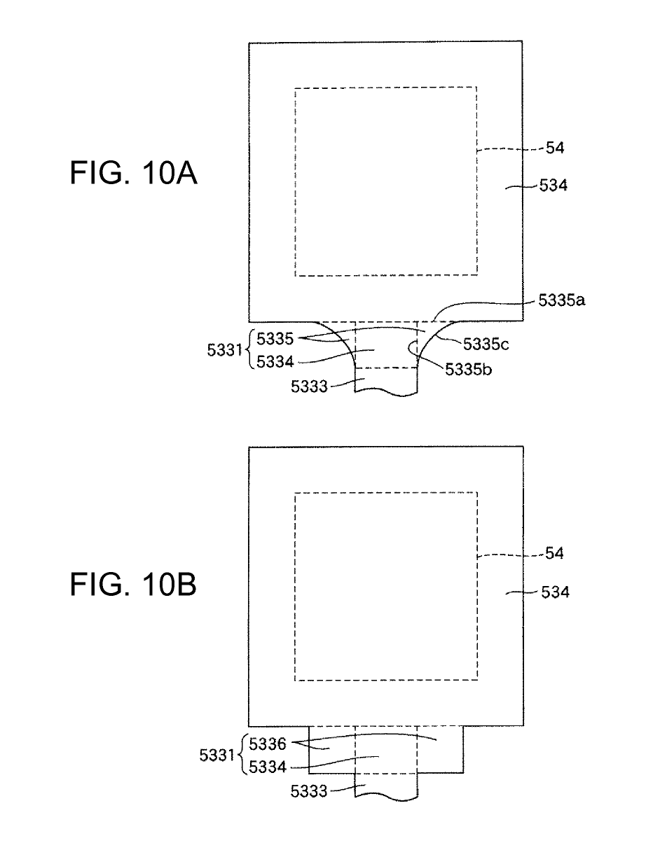

FIGS. 10A and 10B are diagrams illustrating another configuration example of the first beam portion illustrated in FIG. 7.

The first beam portion 5331 illustrated in FIG. 10A is the same as the first beam portion 5331 illustrated in FIG. 7 except that the shape of the oblique side 5335c of the tapered portion 5335 in the plan view has a curved portion. According to the first beam portion 5331, the advantage of reducing the vibration leakage is further reinforced more than the first beam portion 5331 illustrated in FIG. 7. Even when the tapered portion 5335 is provided, it is difficult to increase the resonant frequency of unnecessary vibration mode 2. Therefore, according to the first beam portion 5331 illustrated in FIG. 10A, it is possible to realize the vibrator 1 with the high Q value and excellent vibration characteristics.

At this time, the curved line of the oblique side 5335c may be a convex curved line to the outside of the tapered portion 5335. As illustrated in FIG. 10A, the curved line of the oblique side 5335c is preferably a convex curved line to the inside of the tapered portion 5335. Thus, since stress is rarely concentrated on the connection portion between the fixed base portion 534 and the support portion 533, it is possible to easily increase the Q value and it is possible to further improve the impact-resistant property of the vibrator 1.

When the shape of the oblique side 5335c of the tapered portion 5335 in the plan view has the straight line illustrated in FIG. 7, there are advantages that manufacturing is relatively easy and an individual difference in the shape rarely occurs. Therefore, when the vibrator 1 is mass-produced, a variation in the characteristics for each product is suppressed to the minimum, and thus uniformity of quality is easily achieved.

On the other hand, the first beam portion 5331 illustrated in FIG. 10B is the same as the first beam portion 5331 illustrated in FIG. 7 except that the first beam portion 5331 includes two attachment portions 5336 having a square with two sides which are the same as the bottom sides 5335a and 5335b of the tapered portion 5335, instead of the two tapered portions 5335. According to the first beam portion 5331, the same advantages as the first beam portion 5331 illustrated in FIG. 7 are obtained although the degrees of advantages are not attainable.

The shape of the attachment portion 5336 is not particularly limited, but may be, for example, a polygon such as a quadrangle including a rectangle, a pentagon, or a hexagon or may be a variant shape as well as a square.

### Method of Manufacturing Vibrator

Next, a method of manufacturing the vibrator 1 will be described in brief.

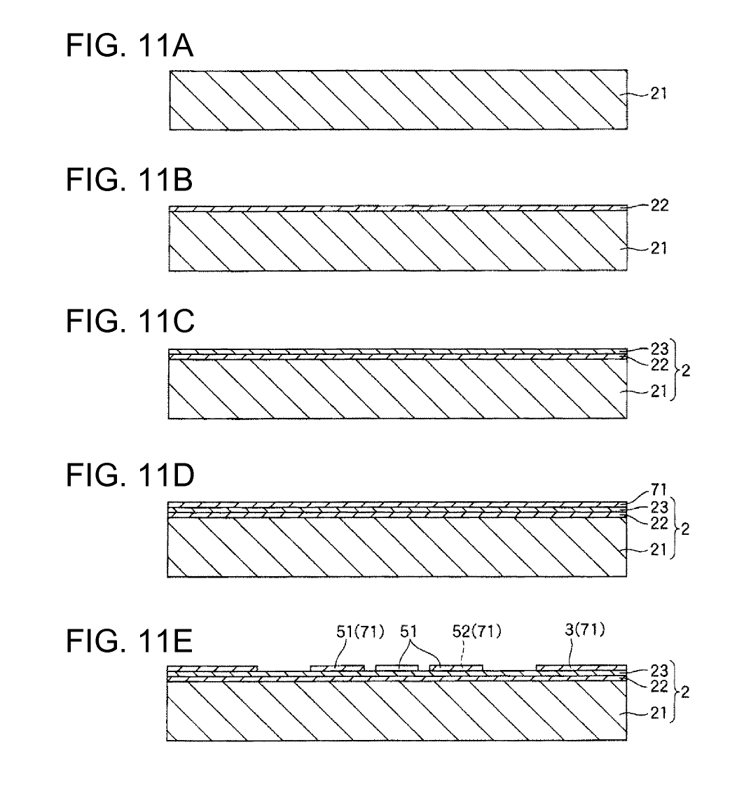

FIGS. 11A to 13C are diagrams illustrating processes of manufacturing the vibrator illustrated in FIG. 1. Hereinafter, the processes will be described with reference to these drawings.

### Process of Forming Vibration Element

First, as illustrated in FIG. 11A, the semiconductor substrate 21 (silicon substrate) is prepared.

When semiconductor circuits are formed on and above the semiconductor substrate 21, the sources and drains of MOS transistors of the semiconductor circuits are subjected to ion-doping to be formed in portions in which the insulation film 22 and the insulation film 23 are not formed in the upper surface of the semiconductor substrate 21.

Next, as illustrated in FIG. 11B, the insulation film 22 (silicon oxide film) is formed on the upper surface of the semiconductor substrate 21.

The method of forming the insulation film 22 (silicon oxide film) is not particular limited. However, for example, a thermal oxidation method (including an LOCOS method and an STI method), a sputtering method, or a CVD method can be used. The insulation film 22 may be subjected to patterning, as necessary. For example, when semiconductor circuits are formed on the upper surface or above the semiconductor substrate 21, the insulation film 22 is subjected to patterning so that a part of the upper surface of the semiconductor substrate 21 is exposed.

Thereafter, as illustrated in FIG. 11C, the insulation film 23 (silicon nitride film) is formed on the insulation film 22.

The method of forming the insulation film 23 (silicon nitride film) is not particularly limited. For example, a sputtering method or a CVD method can be used. The insulation film 23 may be subjected to patterning, as necessary. For example, when semiconductor circuits are formed on the upper surface or above the semiconductor substrate 21, the insulation film 23 is subjected to patterning so that a part of the upper surface of the semiconductor substrate 21 is exposed.

Next, as illustrated in FIG. 11D, a conductor film 71 is formed on the insulation film 23 to form the conductor layer 3 and the lower electrodes 51 and 52.

Specifically, for example, the conductor film 71 is formed by forming a silicon film formed of polycrystalline silicon or amorphous silicon on the insulation film. 23 through a sputtering method, a CVD method, or the like, and then doping impurities such as phosphorus on the silicon film. Depending on the configuration of the insulation film 23, the conductor film 71 may be formed by doping impurities such as phosphorus on a silicon film subjected to epitaxial growth.

Next, the conductor layer 3 and the lower electrodes 51 and 52 are formed by patterning the conductor layer 71, as illustrated in FIG. 11E.

Specifically, for example, a photoresist film is formed by applying photoresist to the conductor film 71 and patterning the photoresist in the shapes (the shapes in the plan view) of the conductor layer 3 and the lower electrodes 51 and 52. Then, the photoresist film is removed after the conductor film 71 is etched using the photoresist film as a mask. Thus, the conductor layer 3 and the lower electrodes 51 and 52 are formed.

When semiconductor circuits are formed on the upper surface or above the semiconductor substrate 21, for example, gate electrodes of the MOS transistors of the semiconductor circuits are formed by pattering the lower electrodes 51 and 52 and the like and simultaneously patterning the conductor film 71.

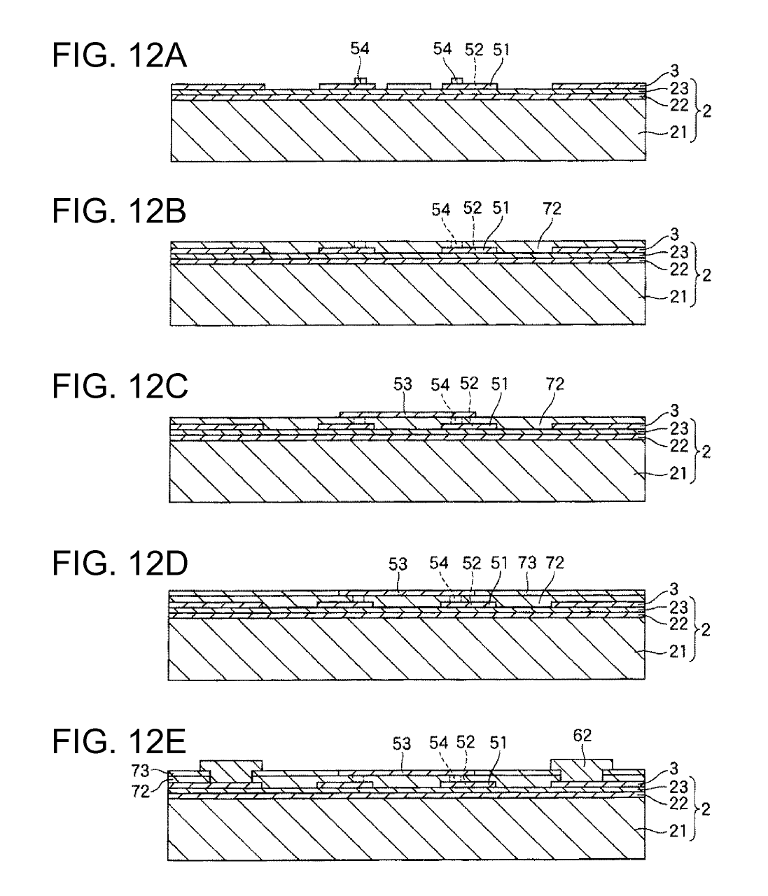

Next, as illustrated in FIG. 12A, the spacer 54 is formed on each lower electrode 52.

The spacers 54 can be formed in the similar way as the way in which the lower electrodes 51 and 52 and the conductor layer 3 described above are formed.

Next, as illustrated in FIG. 12B, a sacrificial layer 72 is formed so that the lower electrodes 51 and 52 and the conductor layer 3 are covered and the spacers 54 are exposed.

In the embodiment, the sacrificial layer 72 is a silicon oxide film and a part of the sacrificial layer 72 is removed in a process to be described below and the remaining portion become a part of the inter-layer insulation film 61.

The method of forming the sacrificial layer 72 is not particularly limited. For example, a sputtering method or a CVD method can be used. When the sacrificial layer 72 is formed, flattening is performed through etch back, chemical mechanical polishing (CMP), or the like, as necessary. The sacrificial layer 72 may be formed only on the lower electrodes 51 and 52 and on the substrate 2 near the lower electrodes 51 and 52 and may not be formed on the conductor layer 3. In this case, almost all the sacrificial layer 72 is removed in a process to be described below.

Next, as illustrated in FIG. 12C, the upper electrode 53 is formed.

Specifically, for example, polycrystalline silicon or amorphous silicon is piled on the sacrificial layer 72 to form a silicon film through a sputtering method, a CVD method, or the like so that the polycrystalline silicon or the amorphous silicon comes into contact with the spacers 54, a conductor film is subsequently formed by doping impurities such as phosphorus on the silicon film, and then the conductor film is subjected to patterning. Depending on the configuration of the sacrificial layer 72, the conductor film may be formed by doping impurities such as phosphorus on the silicon film subjected to epitaxial growth. The silicon film may be subjected to patterning through etch back, chemical mechanical polishing, or the like.

In the patterning on the conductor film, for example, a photoresist film is formed by applying photoresist to the conductor film and patterning the photoresist in the shape (the shape in the plan view) of the upper electrode 53. Then, the photoresist film is removed after the conductor film is etched using the photoresist film as a mask. Thus, the upper electrode 53 is formed.

As described above, the vibration element 5 including the lower electrodes 51 and 52, the upper electrode 53, and the spacer 54 is formed.

### Process of Forming Cavity

As illustrated in FIG. 12D, a sacrificial layer 73 is formed on the sacrificial layer 72.

In the embodiment, the sacrificial layer 73 is a silicon oxide film and a part of the sacrificial layer 73 is removed in a process to be described below and the remaining portion becomes a part of the inter-layer insulation film 61.

The sacrificial layer 73 can be formed in the similar way as the way in which the above-described sacrificial layer 72 is formed.

Next, as illustrated in FIG. 12E, the wiring layer 62 is formed.

Specifically, for example, a through hole with a shape corresponding to the wiring layer 62 is formed by patterning a laminate formed by the sacrificial layers 72 and 73 by etching, a film formed of aluminum is subsequently formed on the laminate through a sputtering method, a CVD method, or the like so that the through hole is buried, the film is subjected to patterning (an unnecessary portion is removed) by etching to form the wiring layer 62.

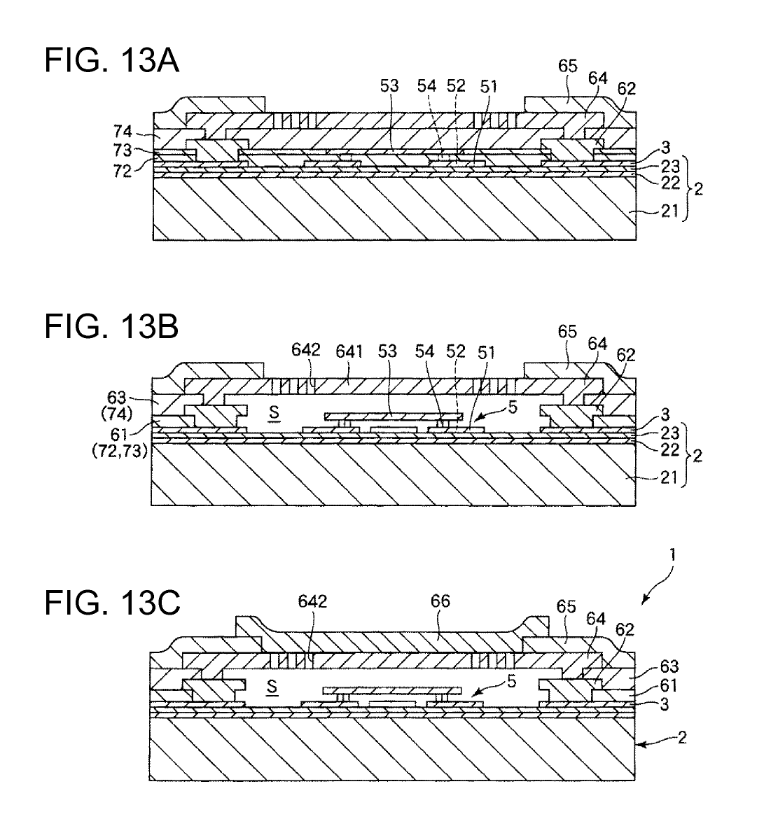

Next, as illustrated in FIG. 13A, a sacrificial layer 74, the wiring layer 64, and the surface protection film 65 are formed in this order on the sacrificial layer 73 and the wiring layer 62.

Specifically, the sacrificial layer 74 is formed on the sacrificial layer 73 and the wiring layer 62 in the similar way as the way in which the above-described sacrificial layers 72 and 73 are formed, and then the wiring layer 64 is formed in the similar way as the way in which the wiring layer 62 is formed. After the wiring layer 64 is formed, the surface protection film 65 which is a silicon oxide film, a silicon nitride film, a polyimide film, or an epoxy resin is formed through a sputtering method, a CVD method, or the like.

A laminated structure of the inter-layer insulation films and the wiring layers is formed through a normal CMOS process and the number of laminated layers is set appropriately, as necessary. That is, more wiring layers are laminated with inter-layer insulation films interposed therebetween, as necessary, in some cases. When semiconductor circuits are formed on the upper surface or above the semiconductor substrate 21, for example, the wiring layers 62 and 64 are formed and wiring layers electrically connected to gate electrodes of MOS transistors or the like of the semiconductor circuits are simultaneously formed.

Next, as illustrated in FIG. 13B, the hollow portion S and the inter-layer insulation films 61 and 63 are formed by removing parts of the sacrificial layers 72, 73, and 74.

Specifically, the sacrificial layers 72, 73, and 74 present in the periphery of the vibration element 5, between the lower electrode 51 and the movable portion 532, and between the substrate 2 and the vibration base portion 531 are removed through the plurality of pores 642 formed in the covering layer 641 by etching. Thus, the hollow portion S accommodating the vibration element 5 is formed and apertures are formed between the lower electrode 51 and the movable portion 532 and between the substrate 2 and the vibration base portion 531, so that the vibration element 5 is in a driving state.

Here, the removing (release process) of the sacrificial layers 72, 73, and 74 can be performed by, for example, wet etching in which a hydrofluoric acid, an aqueous hydrofluoric acid, or the like is supplied as an etchant from the plurality of pores 642 or dry etching in which a hydrofluoric gas or the like is supplied as an etching gas from the plurality of pores 642. At this time, the insulation film 23 and the wiring layers 62 and 64 have a resistant property to the etching performed in the release process, and thus serve as so-called etching stop layers. Since each portion forming the vibration element 5 is also formed of silicon, each portion has a resistant property to the etching performed in the release process. Before the etching, a protective film formed of photoresist or the like may be formed on the outer surface of the structure including portions to be etched, as necessary.

Next, as illustrated in FIG. 13C, the sealing layer 66 is formed on the covering layer 641.

Specifically, for example, the sealing layer 66 including a silicon oxide film, a silicon nitride film, or a metal film such as Al, Cu, W, Ti, or TiN is formed through a sputtering method, a CVD method, or the like to seal each pore 642.

The vibrator 1 can be manufactured through the above-described processes.

### 2. Electronic Apparatus

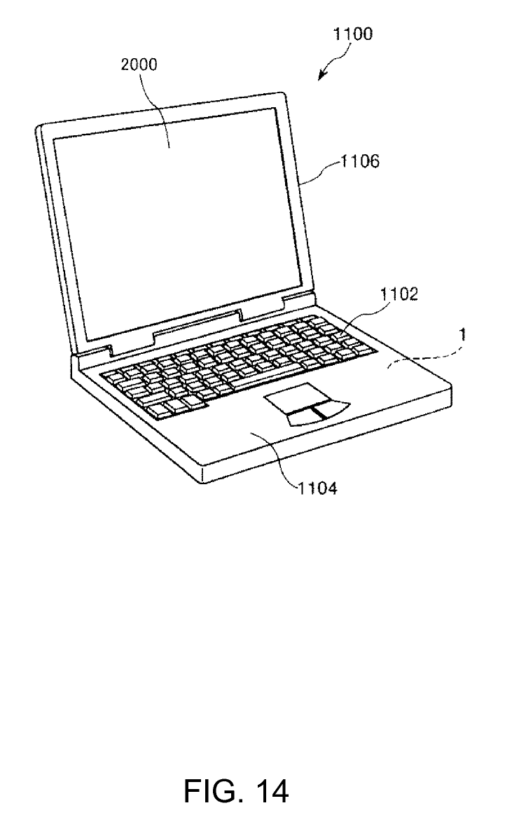

Next, electronic apparatuses (an electronic apparatus according to the invention) including the vibrator according to the invention will be described in detail with reference to FIGS. 14 to 16.

FIG. 14 is a perspective view illustrating the configuration of a mobile (or notebook type) personal computer which is a first example of an electronic apparatus according to the invention. In the drawing, a personal computer 1100 is configured to include a body section 1104 including a keyboard 1102 and a display unit 1106 including a display section 2000. The display unit 1106 is supported to be rotatable with respect to the body section 1104 via a hinge structure section. The vibrator 1 (oscillator) is included inside the personal computer 1100.

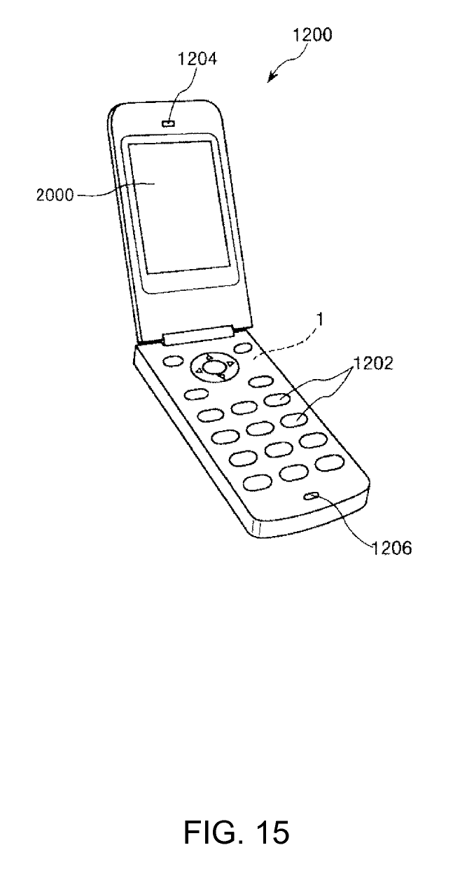

FIG. 15 is a perspective view illustrating the configuration of a mobile phone (including a PHS) which is a second example of the electronic apparatus according to the invention. In the drawing, a mobile phone 1200 includes a plurality of operation buttons 1202, an earpiece 1204, and a mouthpiece 1206. A display section 2000 is disposed between the operation buttons 1202 and the mouthpiece 1204. The vibrator 1 (oscillator) is included inside the mobile phone 1200.

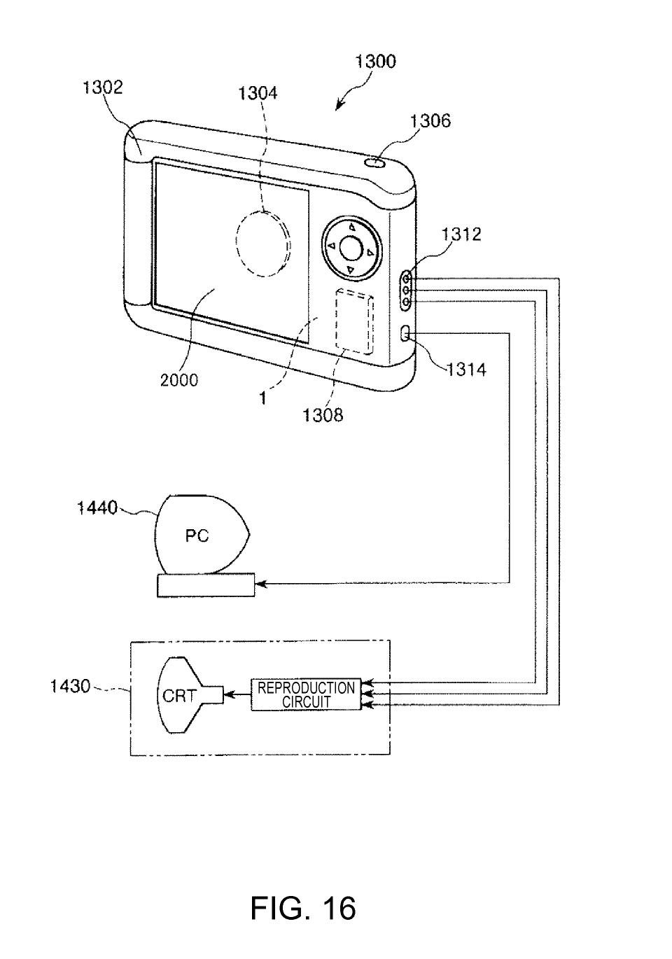

FIG. 16 is a perspective view illustrating the configuration of a digital still camera which is a third example of the electronic apparatus according to the invention. In the drawing, connection to an external apparatus is also simply illustrated. Here, while a normal camera exposes a silver-halide photography film to light by a light image of a subject, a digital still camera 1300 generates an imaging signal (image signal) by performing photoelectric conversion on a light image of a subject by an image sensor such as a charge coupled device (CCD).

A display section 2000 is provided on the back surface of a case (body) 1302 of the digital still camera 1300 and is configured to perform display based on the imaging signal by the CCD, and thus the display section 2000 functions as a finder displaying a subject as an electronic image. A light-receiving unit 1304 including an optical lens (imaging optical system) or a CCD is provided on the front surface side (the rear surface side of the drawing) of the case 1302.

When a photographer confirms a subject image displayed on the display section 2000 and presses a shutter button 1306, an imaging signal of the CCD at this time is transferred and stored in a memory 1308. In the digital still camera 1300, a video signal output terminal 1312 and a data communication input/output terminal 1314 are provided on a side surface of the case 1302. As illustrated, a television monitor 1430 is connected to the video signal output terminal 1312 and a personal computer 1440 is connected to the data communication input/output terminal 1314, as necessary. The imaging signal stored in the memory 1308 is configured to be output to the television monitor 1430 or the personal computer 1440 through a predetermined operation. The vibrator 1 (oscillator) is included inside the digital still camera 1300.

The electronic apparatus including the vibrator according to the invention can be applied not only to the personal computer (mobile type personal computer) in FIG. 14, the mobile phone in FIG. 15, and the digital still camera in FIG. 16 but also to, for example, an inkjet ejecting apparatus (for example, an ink jet printer), a laptop type personal computer, a television, a video camera, a video tape recorder, a car navigation apparatus, a pager, an electronic pocket book (including a communication function unit), an electronic dictionary, a calculator, an electronic game apparatus, a word processor, a workstation, a television phone, a security television monitor, electronic binoculars, a POS terminal, a medical apparatus (for example, an electronic thermometer, a blood-pressure meter, a blood-sugar meter, an electrocardiographic apparatus, an ultrasonic diagnostic apparatus, or an electronic endoscope), a fish finder, various measurement apparatuses, meters (for example, meters for vehicles, airplanes, and ships), and a flight simulator.

### 3. Moving Object

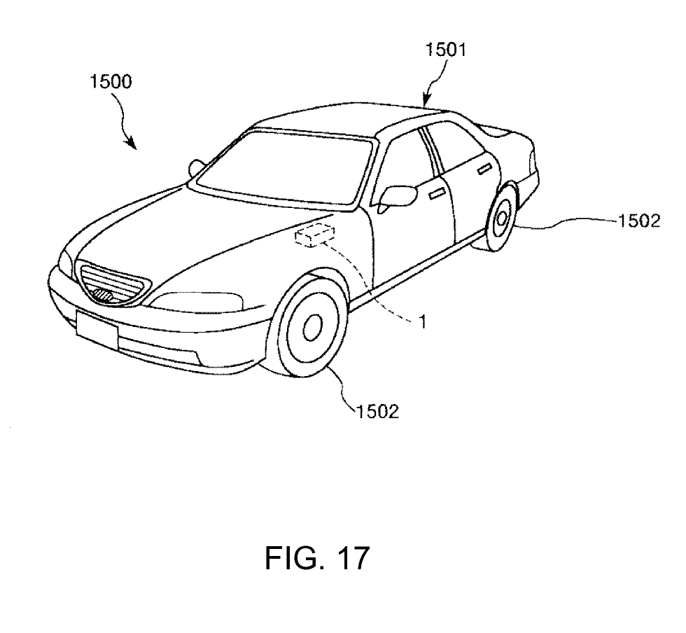

FIG. 17 is a perspective view illustrating the configuration of an automobile which is an example of a moving object according to the invention.

In the drawing, a moving object 1500 includes a body 1501 and four wheels 1502 and is configured such that the wheels 1502 are rotated by a power source (engine) (not illustrated) provided in the body 1501. The vibrator 1 (oscillator) is included inside the moving object 1500.

The moving object according to the invention is not limited to an automobile, but can be applied to, for example, various moving objects such as airplanes, ships, and motorcycles.

The vibrator, the electronic apparatuses, and the moving object according to the invention have been described above according to the illustrated embodiments, but the invention is not limited thereto. The configuration of each unit can be substituted with any configuration of the same function. Any other constituents may be added.

In the above-described embodiments, the case in which the width of the third beam portion of the support portion is constant in the longitudinal direction throughout the entire region has been described, but the third beam portion may have portions with different widths.

In the above-described embodiments, the case in which the area of the fixed electrode in the plan view is greater than the area of the movable portion of the movable electrode has been described. The area of the fixed electrode in the plan view may be the same as the area of the movable portion of the movable electrode or may be less than the area of the movable portion of the movable electrode.

In the above-described embodiments, the case in which the lower electrode and the upper electrode are formed by forming the films has been exemplified, but the invention is not limited thereto. For example, by etching the substrate, the lower electrode or the upper electrode may be formed.

The entire disclosure of Japanese Patent Application No. 2014-192708, filed Sep. 22, 2014 is expressly incorporated by reference herein.

What is claimed is:

1. A vibrator comprising:
a substrate;
a vibration section that is disposed on the substrate;
a fixed base portion that is disposed on the substrate; and
a support portion that extends from the fixed base portion to support the vibration section and includes a portion of which a width decreases from the fixed base portion to the vibration section,
wherein in a connection portion between the fixed base portion and the support portion, a width of the support portion is less than a width of the fixed base portion.

2. The vibrator according to claim 1, wherein the portion with the decreasing width in the support portion is connected to the fixed base portion in the connection portion.

3. The vibrator according to claim 2, further comprising:
a substrate-side electrode that is disposed on the substrate; and
a movable electrode that faces the substrate-side electrode and at least partially overlaps the substrate-side electrode in a plan view when viewed in a thickness direction of the substrate,
wherein the substrate-side electrode and the movable electrode are separated from each other.

4. The vibrator according to claim 3, wherein a plurality of movable electrodes are present.

5. The vibrator according to claim 1, wherein a part of the fixed base portion is fixed to the substrate.

6. The vibrator according to claim 1, wherein in the connection portion between the fixed base portion and the support portion, the width of the support portion is equal to or less than the width of the fixed base portion by 86%.

7. The vibrator according to claim 6, wherein in the connection portion between the fixed base portion and the support portion, the width of the support portion is equal to or greater than the width of the fixed base portion by 54%.

8. The vibrator according to claim 1, wherein in a portion in which the width of the support portion is less than the width of the fixed base portion, an external shape of the portion in the plan view has a curved portion.

9. The vibrator according to claim 1, wherein in a portion in which the width of the support portion is less than the width of the fixed base portion, an external shape of the portion in the plan view has a straight line portion.

10. The vibrator according to claim 1, wherein a plurality of the fixed base portion and a plurality of the support portions are present.

11. An electronic apparatus comprising:
the vibrator according to claim 1.

12. An electronic apparatus comprising:
the vibrator according to claim 2.

13. An electronic apparatus comprising:
the vibrator according to claim 3.

14. An electronic apparatus comprising:
the vibrator according to claim 4.

15. An electronic apparatus comprising:
the vibrator according to claim 5.

16. A moving object comprising:
the vibrator according to claim 1.

17. A moving object comprising:
the vibrator according to claim 2.

18. A moving object comprising:
the vibrator according to claim 3.

19. A moving object comprising:
the vibrator according to claim 4.

20. A moving object comprising:
the vibrator according to claim 5.
